(19) United States
(12) Patent Application Publication
(10) Pub. No.: US 2008/0233262 A1
(43) Pub. Date: Sep. 25, 2008

(54) Healthy food product

(75) Inventors: Constantina Avramopoulou Avramis, Vlaardingen (NL); Angelika De Bree, Vlaardingen (NL); Stanley Heptinstall, Nottingham (GB); Christine Ingrid Kroner, Vlaardingen (NL)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc. d/b/a/ UNILEVER

(21) Appl. No.: 12/077,327

(22) Filed: Mar. 19, 2008

(30) Foreign Application Priority Data
Mar. 20, 2007 (EP) EP07104476

(51) Int. Cl. A23C 9/152; A23L 1/30

(52) U.S. Cl. 426/585; 426/601

(57) ABSTRACT

Food product comprising potassium and omega-3 PUFA wherein the weight ratio of potassium to the total amount of omega-3 PUFA is from 2:1 to 10:1 and use of potassium and omega-3 PUFA in said weight ratio in the preparation of a food product suitable for the reduction of platelet aggregation.

### FIELD OF THE INVENTION

The present invention concerns a food product having one or more health effects. In particular such health effect is related to the reduction of platelet aggregation.

### BACKGROUND PRIOR ART

Many scientific publications have been issued that strongly suggest that regular consumption of significant amounts of polyunsaturated fatty acids can deliver important health benefits. In recent years, omega-3 polyunsaturated fatty acids (omega-3 PUFA) have gained particular attention. A growing body of evidence indicates that foods rich in omega-3 PUFA, especially eicosapentaenoic acid (EPA) and docosahexaenoic acid (DHA), confer cardio protective effects like reduced blood-clotting (i.e. reduced platelet aggregation). See for example Connor et al. 2000, Am. J. Clin. Nutr., 71, 171S-5S.

Hence, many efforts have been made by the industry to develop food products and nutritional preparations that contain appreciable amounts of omega-3 PUFA as these products and preparations may be beneficial for the consumer by reducing platelet aggregation which e.g. may prevent the formation of blood clots.

DE 39 24 607 C2 discloses a dietetic foodstuff that contains a determined amount of long-chain polyunsaturated omega-3 and omega-6 fatty acids, sodium and potassium. The dietetic foodstuff allegedly has particularly advantageous properties for simultaneously preventing and treating several chronic and civilization diseases, e.g. reduction of platelet aggregation. The foodstuff comprises relatively large amounts of omega-3 fatty acids and potassium in an amount of 1.5-5 wt % and 0.3-1.5 wt %, respectively.

WO 01/51088 A1 discloses a composition for reducing, among other things, platelet aggregation comprising (a) at least one unsaturated fatty acid, and at least one of (b) pantethine and (c) at least one antioxidant selected from the group consisting of Vitamin C, Vitamin E, tocotrienol, cartenoids, flavenoids, coenzyme Q10 and grape seed extract. No mention is made of potassium.

Food products containing PUFA often develop an off-flavor which is not desired as these make the food product less palatable. This off-flavor problem is associated with the oxidation of the unsaturated fatty acids, notably the omega-3 PUFA as these are especially prone to oxidation. Oxidation of these unsaturated fatty acids is accompanied by the formation of volatile, potent flavor molecules, such as unsaturated aldehydes. Flavor attributes associated with oxidation products of unsaturated fatty acids include “cardboard”, “paint”, “oily”, “rancid”, “metallic” and “fish”. A fishy off-flavor note typically results from oxidation of omega-3 PUFA and is regarded as particularly objectionable in food products.

It is generally assumed that food products should contain relatively large amounts of omega-3 PUFA to have the desired beneficial health effects like reduced platelet aggregation in a human being. Typical amounts are additions of omega-3 PUFA that allow e.g. for a daily intake of 850 mg and more per day, up to as much of 4 grams. Therefore, most efforts in the industry have been directed at inhibiting the oxidation of the unsaturated fatty acids or by masking the off-flavor to allow the incorporation of the required amount omega-3 PUFA.

EP 809 939, for instance, discloses a yogurt product containing refined fish oil, wherein the yogurt contains specific sweeteners and is packed in an oxygen blocking hermetic package in order to prevent the development of a fishy smell. Other product formats with fish-oil have also been proposed. WO 04/014151 discloses the combined use of encapsulated fish oil and citrus flavor in cereal based food products. These methods require special processing and/or the addition of special ingredients which make these products e.g. difficult to make and/or expensive.

Beneficial health effects of potassium supplementation with respect to heart health benefits have mainly be attributed to blood pressure lowering. The possible effects of potassium supplementation of the human diet on e.g. platelet aggregation is only recently being looked into. See for example Kimura et al.: KCl supplementation diminishes platelet reactivity in humans, Hypertension 44 (2004) pp. 969-973. A relatively large amount of 2340 mg potassium per 70 kg body weight was used in this study.

It is an object of the present invention to provide a food product that can have heart health benefits when consumed. Another object of the present invention is to provide a food product that can be beneficial when consumed in that it can reduce platelet aggregation. It is also an object of the invention to provide a food product that is palatable when consumed. A further object of the present invention is to provide a health beneficial food product that contains relatively low amounts of omega-3 PUFA.

### SUMMARY OF THE INVENTION

It was found that one or more of the above objects can be realized by the use of potassium in a food product comprising omega-3 PUFA. Surprisingly, the use of potassium in a specific weight ratio to the omega-3 PUFA allows for lower amounts of the omega-3 PUFA while maintaining a beneficial health effect.

Accordingly, in a first aspect the invention relates to a food product comprising potassium and omega-3 PUFA wherein the weight ratio of potassium to the total amount of omega-3 PUFA is from 2:1 to 10:1.

The invention also relates to the use of potassium and omega-3 PUFA in a specified weight ratio in the preparation of a food product suitable for the reduction of platelet aggregation.

### DETAILED DESCRIPTION OF THE INVENTION

Omega-3 PUFA are a family of polyunsaturated fatty acids which have in common a carbon-carbon double bound in the omega-3 position. The term omega-3 (also known as “n-3”, “ω-3”) signifies that the first double bond exists as the third carbon-carbon bond from the terminal methyl end of the carbon chain. Omega-3 PUFA includes e.g. alpha-linolenic acid (ALA), 18:3 (n-3); stearidonic acid, 18:4 (n-3); eicosatetraenoic acid, 20:4 (n-3); eicosapentaenoic acid (EPA), 20:5 (n-3); docosapentaenoic acid, 22:5 (n-3) and docosahexaenoic acid (DHA), 22:6 (n-3). For the purpose of the invention the total amount of omega-3 PUFA includes fatty acid residues as well as free fatty acids.

Food products according to the invention comprise potassium and omega-3 PUFA wherein the weight ratio of potassium to the total amount of omega-3 PUFA is from 2:10 to 10:1. Preferably the weight ratio of potassium to the total amount of omega-3 PUFA is from 3:1 to 9:1, more preferably from 4:1 to 8:1 and even more preferably from 6:1 to 8:1. Especially preferred is a weight ratio of potassium to the total amount of omega-3 PUFA from 7:1 to 7.5:1.

The weight ratio of potassium to the total amount of omega-3 PUFA is calculated as the total amount of potassium as described below compared to the total amount of omega-3 PUFA calculated as the total amount of omega-3 PUFA.

The potassium comprised in food products according to the invention may be provided by any source of potassium or combination thereof suitable for use in a food product. Examples of suitable sources of potassium are e.g. potassium chloride, potassium gluconate, potassium lactate and potassium citrate. Preferably the source of potassium for a food product according the invention is potassium gluconate. Also preferred are potassium citrate, potassium lactate or combinations thereof. The amount of potassium is calculated by taking the weight equivalence of the potassium contributed by the potassium source. For example 100 mg of potassium chloride provides approximately 53 mg potassium and 100 mg of potassium citrate provides approximately 38 mg potassium.

Important omega-3 PUFA in nutrition are ALA, EPA and DHA. In the scientific literature many health benefits have been attributed to EPA and DHA, e.g. the reduction of platelet aggregation in humans. Therefore, the omega-3 PUFA for use in food products according to the invention preferably are selected from the group consisting of ALA, EPA, DHA and combinations thereof. More preferably the omega-3 PUFA are selected from the group consisting of EPA, DHA and combinations thereof.

Omega-3 PUFA in general are sensitive to oxidation, and EPA and DHA are particularly sensitive to oxidation and produce pronounced fishy off-flavors. Therefore, the inclusion of omega-3 PUFA, and especially EPA and DHA, in food products may be difficult as the oxidation of the omega-3 PUFA may result in non-palatable food products. We have found that the use of potassium in addition to omega-3 PUFA in a specific weight ratio allows for the use of relatively low amounts of omega-3 PUFA. Therefore, food products according to the invention may be less likely to develop an off-taste but may still provide a health benefit.

Hence, food products according to the invention preferably comprise an amount of omega-3 PUFA from 0.01 to 5 wt %, preferably from 0.03 to 1 wt % and more preferably from 0.05 to 0.5 wt % (calculated on total amount of product).

The omega-3 PUFA may be incorporated in the food product as the omega-3 PUFA per se and as an omega-3 PUFA comprising oil (omega-3 PUFA oil), e.g. vegetable oil, marine oil or fish oil. Preferably the omega-3 PUFA is selected from the group consisting of fish oil, algae oil, linseed oil, soybean oil, rapeseed oil and combinations thereof. The omega-3 PUFA oil may be a processed oil, e.g. the omega-3 PUFA oil may have been refined, concentrated or treated otherwise. Preferably the omega-3 PUFA oil is fish oil, more preferably a concentrated fish oil. Also preferably the omega-3 PUFA oil is a non-encapsulated oil.

Food products of the invention preferably contain further heart health ingredients, particularly preferred is the use of plant sterols, such as for example phytosterols or phytostanols. Preferred plant sterols for use in the food products of the invention are described in more detail below. For the purpose of the invention the term plant sterol refers to sterols, stanols, their analogues and their esters.

Typically, the phytosterols, phytostanols and their analogues and derivatives may be selected from one or more of phytosterols, phytostanols, synthetic analogues of phytosterols and phytostanols and esterified derivatives of any of the foregoing, and mixtures of any of these. The total amount of such substances in a food product is preferably from 0.01 wt % to 20 wt %, more preferably from 0.1 wt % to 15 wt % and most preferably from 0.2 wt % to 8 wt % by weight of the food product composition.

Preferably, the amount of such sterol-type component per daily recommended intake of the food product according to the invention is from 0.1 gram to 3 gram, more preferably from 1.5 gram to 2.5 gram, especially from 2 gram to 2.25 gram.

Phytosterols, also known as plant sterols or vegetable sterols can be classified in three groups, 4 desmethylsterols, 4 monomethylsterols and 4,4′ dimethylsterols. In oils they mainly exist as free sterols and sterol esters of fatty acids although sterol glucosides and acylated sterol glucosides are also present. There are three major phytosterols namely beta sitosterol, stigmasterol and campesterol.

The phytostanols are the respective hydrogenated derivatives of phytosterols such as sitostanol, campestanol.

Synthetic analogues of any of the phytosterols or phytostanols (which include chemically modified natural phytosterols or phytostanols) may be used.

Preferably the phytosterol or phytostanol is selected from the group comprising fatty acid esters of β-sitosterol, β-sitostanol, campesterol, campestanol, stigmasterol, stigmastanol and mixtures thereof.

The optional phytosterol or phytostanol materials recited above may optionally be provided in the form of one or more fatty acid esters thereof. Mixtures of esterified and non-esterified materials may also be used.

Thus, any of the sterols e.g. phytosterols or phytostanols and their synthetic analogues used in the present invention are preferably esterified with a fatty acid. Preferably, they are esterified with one or more C2-22 fatty acids. For the purpose of the invention the term C2-22 fatty acid refers to any molecule comprising a C2-22 main chain and at least one acid group. Although not preferred within the present context the C2-22 main chain may contain 1-6 double bonds, be partially substituted or side chains may be present. Preferably, however the C2-22 fatty acids are linear molecules comprising one or two acid group(s) as end group(s). Most preferred are linear C8-22 fatty acids as occur in natural liquid oils.

Preferably the amount of omega-3 PUFA in the food product is chosen such that per daily recommended intake of the food product the amount of omega-3 PUFA is from 40 to 500 mg, more preferably from 50 to 250 mg and even more preferably from 70 to 100 mg.

The daily recommended intake of a food product may be consumed in one portion the size of the daily recommended intake or in several portions during the day, wherein the total amount of the portions equals the daily recommended intake. Suitable daily recommended intake for several food products is indicated in Table 1.

TABLE 1
Suitable daily recommended intake for selected food
products

| | Daily recommended | | | |
|---|---|---|---|---|
| Food product | intake | | Typical portion | |
| Spread | 30 | gram | 10 | gram |
| Dairy drink | 100-130 | gram | 100-130 | gram |
| Fruit juice | 200 | gram | 200 | gram |
| Frozen | 75 | gram | 75 | gram |
| confectionary | | | | |
| product | | | | |
| Sauce | 40 | gram | 40 | gram |
| Bar | 60 | gram | 60 | gram |

Food products according to the invention preferably are selected from the group consisting of drinks and spreads.

Examples of drinks are fruit juice, soy based drinks and dairy drinks such as milk, milk based drinks and yogurt based drinks. Preferably the food product is a dairy drink, more preferably a yogurt based drink. A typical daily recommended intake for a yoghurt based drink could be from 50 to 250 gram, generally from 80 to 200 gram.

Advantageously the food product according to the invention is a dairy drink comprising 0.47 wt % potassium and 0.065 wt % of a combination of DHA and EPA. Even more advantageously the dairy drink further comprises 2.62 wt % plant sterol esters. More preferably the daily recommended intake of the dairy drink is 130 gram.

Spreads are water and oil emulsions and include oil in water emulsions (o/w), water in oil emulsions (w/o) and more complex emulsions such as water in oil in water emulsions (w/o/w). Examples of spreads are water in oil emulsions such as margarine and oil in water emulsions such as dairy spread alternatives. Oil is herein defined as including fat. Advantageously the food product is a margarine.

Food products according to the invention can be prepared by the skilled person based on common general knowledge, comprising the addition of potassium and omega-3 PUFA in suitable amounts. Examples of food products according to the invention are provided hereafter.

The invention further relates to the use of potassium and omega-3 PUFA in the preparation of a food product suitable for the reduction of platelet aggregation is humans, wherein the weight ratio of potassium to the total amount of omega-3 PUFA is from 2:10 to 10:1, preferably from 3:1 to 9:1, more preferably from 4:1 to 8:1 and even more preferably from 6:1 to 8:1.

### EXAMPLES

### Example 1

A food product according to the invention may be a spread according to the composition in Table 2.

TABLE 2
Spread*

| Ingredient: | Amount (wt %): |
|---|---|
| Fat phase | |
| Sunflower oil | 29 |
| Refined interesterified mixture of: | 6 |
| 35 parts palm kernel; and 65 parts | |
| palm oil stearine. | |
| Fish oil** | 2 |
| Sterol esters | 4.5 |
| emulsifier | 0.3 |
| Anti-oxidants | 0.1 |
| Water phase | |
| Potassium chloride | 3.8 |
| Citric acid | 0.04 |
| Water | Remainder up to 100% |

*Spread comprises per 100 gram approximately 2 g potassium, approximately 1.03 g omega-3 and approximately 0.800 g EPA + DHA.
**Marinol ™ C-38 from Lipid Nutrition, comprising 52 wt % on total amount of fish oil of omega-3, comprising 40 wt % on total amount of fish oil of EPA + DHA.

### Example 2

A food product according to the invention may be a drink according to the composition in Table 3.

TABLE 3
Drink* (100 gram)

| Ingredient: | Amount (wt %): |
|---|---|
| Skimmed yoghurt (4.0% protein on total | 68.80000 |
| amount of skimmed yoghurt); comprising | |
| 0.12 wt % of potassium (on total amount of | |
| composition). | |
| Thickener | 0.30000 |
| Sweetener | 0.0130 |
| Emulsifier | 0.0050 |
| Potassium Gluconate | 2.727 |
| Oligosaccharides | 1.1800 |
| Fish oil** | 0.210 |
| Anti-oxidants | 0.06000 |
| Sterolesters | 3.4 |
| Fruit puree | 5 |
| Water | remainder up to 100% |

*Dairy drink of 100 gram comprises approximately 600 mg potassium, approximately 109 mg omega-3 and approximately 84 mg EPA + DHA.
**Marinol ™ C-38 from Lipid Nutrition, comprising 52 wt % on total amount of fish oil of omega-3, comprising 40 wt % on total amount of fish oil of EPA + DHA.

### Example 3

A food product according to the invention was prepared in the form of a dairy drink and the effect of the dairy drink on platelet aggregation was tested with human subjects.

Subjects

Apparently healthy subjects were recruited from a pool of volunteers. A total of 88 subjects (32 males and 56 females) were included in the study. The most important eligibility criteria were an age between 45-70 years, body mass index between 18-35 kg/m2, with no medical history that could affect the study outcome, not taking (over the counter) medication or supplements that may affect blood platelet function in the month prior to baseline and during the study.

Study Design

Subjects drank 1 bottle with 130 gram of a dairy drink as described below (Table 4).

On the test day the included subjects consumed the dairy drink and there were three blood drawing time points: just before consuming the test drink (T0) and three (T3) and five (T5) hours after consumption of the test drink. The study manager as present while consuming the test drink to guarantee compliance.

Dairy Drinks

A dairy drink of 130 gram was prepared with the composition as indicated in Table 4.

TABLE 4
Dairy Drink Composition* (130 gram)

| Ingredient: | Amount (wt %): |
|---|---|
| Skimmed yoghurt (4.0% protein on total | 68.8 |
| amount of skimmed yoghurt); comprising | |
| 0.12 wt % of potassium (on total amount of | |
| composition). | |
| Pectin AMD783 | 0.3 |
| Sucralose | 0.013 |
| Dimodan HP75 | 0.005 |
| Potassium Gluconate | 2.0977 |
| Actilight 950P | 1.18 |
| Fish oil** | 0.16154 |
| Sodium pyro phosphate | 0.01 |
| Y-tocopherol | 0.05 |
| Sterolesters | 2.61538 |
| Fruit puree | 5 |
| Water | remainder up to 100% |

*Dairy drink of 130 gram comprises approximately 600 mg potassium, approximately 109 mg omega-3 and approximately 84 mg EPA + DHA.
**Marinol ™ C-38 from Lipid Nutrition, comprising 52 wt % on total amount of fish oil of omega-3, comprising 40 wt % on total amount of fish oil of EPA + DHA.

Platelet Function

Platelet function was measured as platelet aggregation tendency in response to adenosine di-phosphate (ADP) and collagen stimulation in blood samples taken at the three time-points on a test day. Blood (9 ml) was dispensed into a plastic graduated tube containing 1 ml 3.13% w/v tri-sodium citrate. Samples were transferred from the clinical area to the laboratory within 10 min of collection. On receipt of the blood sample by the laboratory it was checked to ensure it had been correctly labeled (Volunteer ID and time-point) and there was no evidence of the sample having clotted. It was then centrifuged, within 20 min of collection, at room temperature for 10 min at 1100 rpm (180 g), in an MSE Centaur 2 bench centrifuge. After centrifugation of the sample, the upper turbid layer of platelet rich plasma (PRP) was removed and dispensed into a clean tube. The platelet count of the PRP was counted using the Sysmex KX-21 haematology analyser. The residual blood was centrifuged at 3,000 rpm for 10 min to obtain platelet poor plasma (PPP). If the PPP appeared turbid it was re-centrifuged or filtered to obtain a clear sample and placed in a clean tube. Using the autologous PPP the platelet count of the PRP was adjusted to 250,000/μl. Within 40 min of blood collection, 480 μl aliquots of PRP were dispensed into four cuvettes that contained stir bars and placed in the incubation wells of the PAP-4 aggregometer operating at a stirrer speed of 1000 rpm and a temperature of 37° C. The samples were left to incubate for 1min and then transferred to the stirring well channels pre-calibrated using autologous PPP as a blank. The samples were stirred for a further 1 min and then activated by the addition of 20 μl of agonist (ADP, 3 μM and 7.5 μM and Collagen, 1 mg/L and 3 mg/L). The aggregation profile was recorded for each channel during 6 min after addition of the agonist. The maximum and final extent of the aggregation response as % aggregation was then recorded. In addition, measurements of lag time for the collagen-induced aggregation were made and recorded. The Area Under the aggregation Curves-(AUC) induced by ADP was derived from the hardcopies of the curves. Finally, platelet P-selectin expression in un-stimulated whole blood was also measured using flow cytometry. These results were expressed as median fluorescence (mf, arbitrary units).

Statistical Analysis

The most accepted parameters to study platelet function are area under the curve (AUC) (arbitrary units) in response to ADP stimulation and lag time (seconds) in response to collagen stimulation. Besides these a complementary method to look at the tendency of platelets to clot is to look at P-selectin expression of platelets in blood samples that have not been stimulated by ADP or collagen. For these variables, the relative change from baseline was calculated at T3 and T5 in the following way:

Relative change of X at T3=(X at T3−X at T0)/X at T0

Relative change of X at T5=(X at T5−X at T0)/X at T0

The effects of the dairy drink on these relative changes were evaluated by means of an analysis of variance as implemented in the statistical software package SAS/STAT (version 8.02, SAS Institute, Cary, N.C.).

Results

Four out of five parameters changed significantly in the direction of reduced platelet aggregation 3 and 5 hours after drinking the dairy drink (see Table 5).

TABLE 5
Effect of the dairy drink on platelet aggregation

| Parameter | T3 # | T5 # |
|---|---|---|
| Relative change in AUC in response to | −6.59%* | −9.52%* |
| 3.0 μmol/L ADP | | |
| Relative change in AUC in response to | −0.10% | −0.04% |
| 7.5 μmol/L ADP | | |
| Relative change in lag time in response | −8.77%* | −12.29%* |
| to collagen 3 mg/L | | |
| Relative change in lag time in response | −11.6%* | −14.7%* |
| to collagen 1 mg/L | | |
| Relative change in P-selectin expression | −6.23* | −11.86* |
| in un-stimulated platelets | | |

# Values are LSMeans, n = 88; T3: 3 hours after consuming the dairy drink; T5: 5 hours after consuming the dairy drink.
*Statistically significant reductions as compared to baseline.

1. Food product comprising potassium and omega-3 PUFA wherein the weight ratio of potassium to the total amount of omega-3 PUFA is from 2:1 to 10:1.

2. Food product according to claim 1 wherein the weight ratio of potassium to the total amount of omega-3 PUFA is from 3:1 to 9:1, preferably from 4:1 to 8:1 and more preferably from 6:1 to 8:1.

3. Food product according to claim 1 wherein the amount of omega-3 PUFA is from 0.01 wt % to 5 wt %, preferably from 0.03 wt % to 1 wt % and more preferably from 0.05 wt % to 0.5 wt %.

4. Food product according to claim 1 wherein the amount of omega-3 PUFA per total amount of the daily recommended intake of the food product is from 40 mg to 500 mg, preferably from 50 mg to 250 mg and more preferably from 70 mg to 100 mg.

5. Food product according to claim 1 further comprising plant sterol in an amount from 0.01 wt % to 20 wt %, preferably from 0.1 wt % to 15 wt %, more preferably from 0.2 to 8 wt %.

6. Food product according to claim 1 wherein the omega-3 PUFA are selected from the group consisting of EPA, DHA and combinations thereof.

7. Food product according to claim 1 wherein the omega-3 PUFA are provided by an oil selected from the group consisting of fish oil, algae oil, linseed oil, soybean oil, rapeseed oil and combinations thereof.

8. Food product according to claim 1 wherein the food product is selected from the group consisting of dairy type products, drinks and spreads.

9. Use of potassium and omega-3 PUFA in the weight ratio according to claim 1 in the preparation of a food product suitable for the reduction of platelet aggregation.

10. Use of potassium and omega-3 PUFA according to claim 9 wherein the omega-3 PUFA are selected from the group consisting of EPA, DHA and combinations thereof.
